(19) United States
(12) Patent Application Publication
(10) Pub. No.: US 2020/0253403 A1
(43) Pub. Date: Aug. 13, 2020

(54) Biodegradable Drinking Straw

(71) Applicant: CHIEN-CHUNG HUANG, Taichung City (TW)

(72) Inventor: CHIEN-CHUNG HUANG, Taichung City (TW)

(21) Appl. No.: 16/862,477

(22) Filed: Apr. 29, 2020

Related U.S. Application Data
(63) Continuation-in-part of application No. 16/036,616, filed on Jul. 16, 2018.

(51) Int. Cl. A47G 21/18; B29B 7/90; B29C 48/00; B29C 48/09

(52) U.S. Cl. CPC A47G 21/18; B29B 7/90; B29K 2401/00; B29C 48/09; B29C 48/022

(57) ABSTRACT

A biodegradable drinking straw and a manufacturing method thereof, the biodegradable drinking straw includes: a plant fiber material, which accounts for 5 wt % to 60 wt % of the total weight of the biodegradable drinking straw; and a biodegradable plastic selected from polylactic acid (PLA), polybutylene succinate (PBS) or a combination thereof; the biodegradable plastic accounts for 40 wt % to 95 wt % of the total weight of the biodegradable drinking straw; the fiber material is mixed into the biodegradable plastic and mixed uniformly and then extruded to form a tube body of the biodegradable drinking straw by extrusion molding. By replacing the traditional straw material with plant fibers and biodegradable plastics, the biodegradable drinking straw can be quickly decomposed naturally in the environment after being buried, thus reducing environmental pollution, and meeting the environmental protection requirements.

This application is a continuation in part of U.S. patent application Ser. No. 16/036,616 which claims the benefit of the earlier filing date of Jul. 16, 2018, the entire specification of which is incorporated herein.

### BACKGROUND

### Technical Field

The present invention relates to drinking straws, and more particularly to a biodegradable drinking straw and a method for manufacturing the same.

### Description of Related Art

Nowadays, drinking straws commercially available can be divided into three types by material, namely plastic, glass, and stainless steel.

Most existing plastic drinking straws are made of material extracted form petroleum. When used to consume high-temperature drinks, such a plastic drinking straw may release toxic components like plasticizer. Plastic drinking straws are also suspected to become a source of toxicity when contacting and being eroded by acidic drinks. Especially, organic juice bars where most drinks contain abundant fruit acids are more vulnerable to the potential toxicity of plastic drinking straws.

Glass drinking straws are made of silica (SiO₂) and other auxiliary components mixed in different proportions through different processes depending on their final applications. In manufacturing, glass drinking straws are formed at a temperature as high as 1600° C. and then cooked in an annealing furnace. However, the high brittleness makes glass drinking straws tends to accidentally break and cause production loss.

Stainless steel drinking straws are made with high energy consumption. Three of the four furnaces used in the manufacturing process have to be heated to about 1500° C. Although some modern factories have their own co-generation systems and/or waste heat recovery systems, there is still a considerable amount of waste gas and heat emitted to the environment. The fact that steel needs huge energy to perform transformation makes such a product unavoidably require high environmental costs.

From the perspective of manufacturing, both glass drinking straws and stainless steel drinking straws consume huge energy from material input to production. This energy consumption terribly exploits natural resources and aggravates the greenhouse effects. On the other hand, plastic drinking straws may contain a great quantity of plasticizer, which can be dissolved by and enter drinks of high temperature or containing esters. The human body may have difficulty in decomposing or excreting plasticizer it intakes. Like other plastic products, drinking straws containing plasticizer when come into long-term contact with children can induce precocious puberty and infertility and increase the risk of asthma and allergy, raising concerns about health and safety.

Hence, how to address the foregoing problems and shortcomings seen in the prior art is an issue for the inventor of the present invention and people in the relevant industries to work on.

### BRIEF SUMMARY OF THE INVENTION

The objective of the present invention is to provide a biodegradable drinking straw and a method for making the same, wherein the biodegradable drinking straw is made of polylactide (PLA), polybutylene succinate (PBS) or a combination thereof, which uses plant fiber materials to replace traditional plastic, glass or stainless steel materials, so that straws can be quickly decomposed naturally in the environment after being buried, thus reducing environmental pollution and meeting environmental protection demands.

To achieve the above objective, a biodegradable drinking straw provided by the invention comprises:

a plant fiber material, which accounts for 5 wt % to 50 wt % of the total weight of the biodegradable drinking straw; and

a biodegradable plastic selected from polylactic acid (PLA), polybutylene succinate (PBS) or a combination thereof; the biodegradable plastic accounts for 50 wt % to 95 wt % of the total weight of the biodegradable drinking straw; the fiber material is mixed into the biodegradable plastic and mixed uniformly and then extruded to form a tube body of the biodegradable drinking straw by extrusion molding.

In an embodiment of the biodegradable drinking straw of the invention, a thickness of the tube body is 80 to 800 μm.

In an embodiment of the biodegradable drinking straw of the invention, the biodegradable plastic is selected from polylactic acid (PLA) or a combination of polylactic acid (PLA) and polybutylene succinate (PBS).

In an embodiment of the biodegradable drinking straw of the invention, the biodegradable drinking straw has a tensile strength of 30-60 MPa.

In an embodiment of the biodegradable drinking straw of the invention, the biodegradable drinking straw has a tensile modulus of 1-7 GPa.

In an embodiment of the biodegradable drinking straw of the invention, the biodegradable drinking straw has a rupture strain of 0.5-3.5%.

In an embodiment of the biodegradable drinking straw of the invention, the biodegradable drinking straw has a break point elongation of 0.05-2.53%.

In an embodiment of the biodegradable drinking straw of the invention, the plant fiber material is selected from sugarcane fiber, bamboo fiber, coconut fiber, palm husk fiber, coffee grounds, wine meal, wheat meal, cotton, hemp fiber, rice straw, rice husk, corn stalk, starch, wood flour or a combination thereof.

The present invent invention further provides a method for manufacturing a biodegradable drinking straw, which comprises:

providing a plant fiber material, which accounts for 5 wt % to 50 wt % of the total weight of the biodegradable drinking straw;

providing a biodegradable plastic, which is selected from polylactic acid (PLA), polybutylene succinate (PBS), or a combination thereof; the biodegradable plastic accounts for 50 wt % to 95 wt % of the total weight of the biodegradable drinking straw;

mixing uniformly the plant fiber material and the biodegradable plastic at a temperature of 120 to 145° C., and then extrusion molding at 140 to 230° C. to form a tube body of the biodegradable drinking straw.

In an embodiment of the method for manufacturing the biodegradable drinking straw of the invention, the biodegradable plastic is selected from polylactic acid (PLA) or a combination of polylactic acid (PLA) and polybutylene succinate (PBS).

In an embodiment of the method for manufacturing the biodegradable drinking straw of the invention, the biodegradable drinking straw has a tensile strength of 30-60 MPa.

In an embodiment of the method for manufacturing the biodegradable drinking straw of the invention, the biodegradable plastic is selected from polylactic acid (PLA) or a combination of polylactic acid (PLA) and polybutylene succinate (PBS), the biodegradable drinking straw has a tensile modulus of 1-7 GPa.

In an embodiment of the method for manufacturing the biodegradable drinking straw of the invention, the biodegradable plastic is selected from polylactic acid (PLA) or a combination of polylactic acid (PLA) and polybutylene succinate (PBS), the biodegradable drinking straw has a rupture strain of 0.5-3.5%.

In an embodiment of the method for manufacturing the biodegradable drinking straw of the invention, the biodegradable plastic is selected from polylactic acid (PLA) or a combination of polylactic acid (PLA) and polybutylene succinate (PBS), the biodegradable drinking straw has a break point elongation of 0.05-2.53%.

In an embodiment of the method for manufacturing the biodegradable drinking straw of the invention, plant fiber material is selected from sugarcane fiber, bamboo fiber, coconut fiber, palm husk fiber, coffee grounds, wine meal, wheat meal, cotton, hemp fiber, rice straw, rice husk, corn stalk, starch, wood flour or a combination thereof.

The biodegradable drinking straw and the manufacturing method of the invention can replace the drinking straws made of traditional plastic materials, and when buried in landfills, the biodegradable drinking straw of the invention can be degraded by microorganisms and decay, eventually becoming a part of the nature again. Besides, the biodegradable drinking straw is made of neither non-petrochemical materials nor silica, so its production avoids excessively consuming the finite resources, thereby being contributive to energy conservation and environmental protection.

With regard to the techniques, means and other effects adopted by the present invention to achieve the above-mentioned objectives, the preferred and feasible embodiments are described in detail below in conjunction with the drawings.

### BRIEF DESCRIPTION OF THE SEVERAL VIEWS OF THE DRAWINGS

FIG. 1 is a three-dimensional schematic view of the environmentally friendly straw of the present invention;

FIG. 2 is a partially magnified schematic cross-sectional view of a biodegradable drinking straw made of plant fiber material and polylactic acid (PLA) according to the present invention; and

FIG. 3 is a partially magnified schematic cross-sectional view of a biodegradable drinking straw made of plant fiber material, polylactic acid (PLA), and polybutylene succinate (PBS).

### DETAILED DESCRIPTION OF THE INVENTION

In order to facilitate the understanding of the present invention, the following will be described in conjunction with the embodiments.

Some embodiments of the features and advantages of the present invention will be described in detail in the following description. It should be understood that the present invention can have various changes in different forms, but it does not deviate from the scope of the present invention, and the descriptions and drawings therein are essentially used for explanation rather than limitation of this invention.

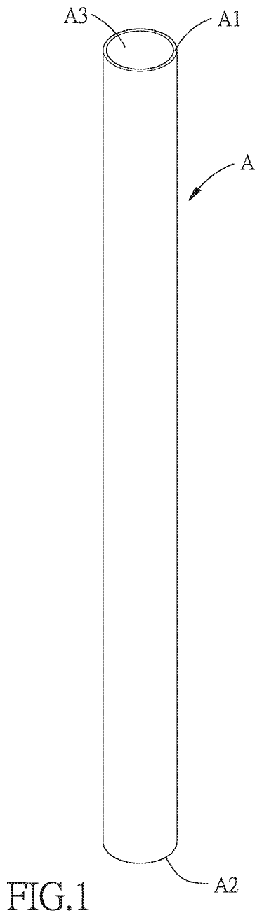

Referring to FIGS. 1-3, the present invention embodiment provides a biodegradable drinking straw, which is composed of plant fiber material and biodegradable plastic, wherein the plant fiber material is selected from sugarcane fiber, bamboo fiber, coconut Fiber, palm husk fiber, coffee grounds, wine meal, wheat meal, cotton, hemp fiber, rice stalk, rice husk, corn stalk, starch, wood flour or a combination thereof. The biodegradable plastic is selected from polylactide acid (PLA), polybutylene succinate (PBS) or a combination thereof. In the embodiment of the present invention, the composition ratio of the biodegradable drinking straw includes plant fiber material that accounts for 5 wt % to 60 wt % of its total weight, and biodegradable plastic that accounts for 40 wt % to 95 wt % of its total weight; The plant fiber material is compounded into the biodegradable plastic and mixed uniformly before extrusion molding to form the tube body A of the biodegradable drinking straw.

As shown in FIG. 1, the tube body A has a first end surface A1, a second end surface A2 opposite to the first end surface A1, and a hole A3 penetrating the first end surface A1 and the second end surface A2. In this embodiment, the thickness of the tube body A may be 80 to 800 μm, preferably 100 to 300 μm.

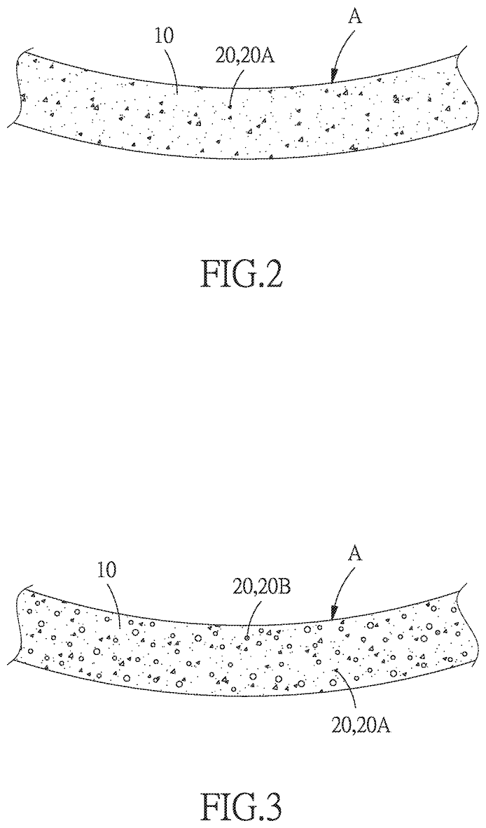

In the embodiment of the invention, the biodegradable plastic is preferably polylactic acid (PLA), or a combination of polylactic acid (PLA) and polybutylene succinate (PBS). As shown in FIG. 2, it shows a cross-sectional view of the structure of the tube body A of the biodegradable drinking straw of the invention made of the plant fiber material 10 and the polylactic acid 20A, wherein the plant fiber material 10 is represented by dots, the polylactic acid 20A (PLA) is represented by triangles. As shown in FIG. 3, a cross-sectional view of the structure of the pipe body A of the biodegradable drinking straw of the invention made of the plant fiber material 10, polylactic acid 20A, and polybutylene succinate 20B is shown, wherein the plant fiber material 10 is represented by dots, and the polybutylene succinate 20B (PBS) is represented by circles.

In the embodiment of the present invention, the plant fiber can be selected from vertical fibers or cotton fiber plant fibers, and then appropriately pretreated into a powder form and mixed into a biodegradable plastic. Specifically, the pretreatment steps of the plant fiber material include drying the obtained plant fiber, and then pulverizing the plant fiber to a preset material powder fineness with a grinder, so as to obtain a plant fiber material suitable for mixing into biodegradable plastic. In the foregoing pretreatment steps, according to the size of the inlet of the grinder, the dried plant fiber can be cut to an appropriate size before being put into the grinder.

The above describes the structural features of the biodegradable drinking straw of the present invention. The following describes the manufacturing method of the biodegradable drinking straw of the present invention; the steps of the manufacturing method include:

Step 1: Providing a plant fiber material, which accounts for 5 wt % to 60 wt % of the total weight of the biodegradable drinking straw;

Step 2: Providing a biodegradable plastic, which is selected from polylactic acid (PLA), polybutylene succinate (PBS), or a combination thereof; the biodegradable plastic accounts for 40 wt % to 95 wt % of the total weight of the biodegradable drinking straw;

Step 3: Mixing and mixing uniformly the plant fiber material and the biodegradable plastic at a temperature of 120 to 145° C., and then extrusion molding at 140 to 230° C. to form the tube body of the biodegradable drinking straw.

The above sequence of steps is not used to limit the manufacturing method of the biodegradable drinking straw of the present invention, and the sequence can be adjusted according to actual operation needs. Wherein, the plant fiber material further includes the steps of the aforementioned plant fiber pretreatment method before step one, so as to enhance the mutual fusion effect of the plant fiber and the biodegradable plastic. Among them, the step 3 is to mix the plant fiber material and the biodegradable plastic according to a certain ratio to prepare raw materials suitable for processing; specific processing steps may include: metering→mixing→stirring→plasticizing→extruding→pelletizing→packaging.

In the embodiment of the present invention, the plant fiber material of the biodegradable drinking straw is sugarcane fiber, and the biodegradable plastic is selected from polylactic acid (PLA) or a combination of polylactic acid (PLA) and polybutylene succinate (PBS). The tube body of the produced biodegradable drinking straw has a tensile strength of 30˜60 MPa, a tensile modulus of 1˜7 GPa, a rupture strain of 0.5˜3.5%, and a break point elongation of 0.05˜2.53%.

In the following, please refer to Table 1 to Table 5 to illustrate the embodiment of the ratio of the biodegradable drinking straw of the present invention and its mechanical property test and the thickness of the tube body (μm).

As shown in Table 1, the ratio of the plant fiber material and the biodegradable plastic of embodiments 1 to 6 of the biodegradable drinking straw of the invention are described. The plant fiber material is sugarcane fiber, and the biodegradable plastic is polylactic acid (PLA) (as in embodiments 1 and 2), polybutylene succinate (PBS) (as in embodiments 3 and 4) or a combination of polylactic acid (PLA) and polybutylene succinate (PBS) (as in embodiments 5 and 6).

TABLE 1

| | |
|---|---|
| Plant fiber | biodegradable plastic |

| | sugarcane fiber | PLA | PBS |
|---|---|---|---|
| | (wt %) | (wt %) | (wt %) |
| embodiment1 | 33 | 67 | — |
| embodiment2 | 42 | 58 | — |
| embodiment3 | 40 | — | 60 |
| embodiment4 | 28 | — | 72 |
| embodiment5 | 42 | 37 | 21 |
| embodiment6 | 45 | 20 | 35 |

In Tables 2 to 5, PLA means pure polylactic acid (PLA); PLA/PBS-20 means PLA mixed with PBS and 20% sugarcane fiber; PLA/PBS-40 means PLA mixed with PBS and then mixed 40% sugarcane fiber; PLA/PBS-60 means PLA mixed with PBS and then 60% sugarcane fiber.

As shown in Tables 2 to 5, the mechanical property test results of the embodiment of the biodegradable drinking straw of the present invention are described. Embodiments are plant fiber made biodegradable drinking straws, which include pure polylactic acid (PLA) (Embodiment 13), the combination of polylactic acid (PLA) and polybutylene succinate (PBS) by 20 wt % (Embodiment 14), the combination of polylactic acid (PLA) and polybutylene succinate (PBS) by 40 wt % (Embodiment 15), the combination of polylactic acid (PLA) and polybutylene succinate (PBS) by 60 wt % (Embodiment 16).

The results of the experimental data of the present invention show that the mechanical properties of the biodegradable drinking straws made of composite materials of polylactic acid (PLA), polybutylene succinate (PBS) and natural sugarcane fiber. Not only can the various heat resistance properties and impact resistance properties be improved, but also the tensile strength and physical strength can be significantly enhanced. In the embodiment of the present invention, when the sugarcane fiber (that is, the plant fiber material 10) accounts for 10 to 40% by weight, the reinforcing effect is the best, which proves that the sugarcane fiber has a reinforcing effect on various physical properties. It can be seen from Table 2 to Table 5 that the reinforcing effect is the best when PLA/PBS (namely, the biodegradable plastic 20) is added with 10 to 40 wt % of sugarcane fiber. When the sugarcane fiber content exceeds 40 wt %, various physical properties begin to decline. Therefore, the content range of sugarcane fiber is preferably between 10 and 40 wt %.

Table 2 shows the relationship between the heat distortion temperature (HDT) of PLA/PBS-sugarcane fiber composites.

TABLE 2

| | HDT | Improvement HDT |
|---|---|---|
| | (° C.) | (° C.) |
| embodiment7 (PLA) | 62.56 | — |
| embodiment8 (PLA/PBS-20) | 84.5 | 35 |
| embodiment9 (PLA/PBS-40) | 97.3 | 56 |
| embodiment10 (PLA/PBS-60) | 83.39 | 27 |

Table 3 shows the DSC detection relationship of PLA/PBS-sugar cane fiber composite materials.

TABLE 3

| | Tg | Tc | Tm | ΔHc | ΔHm |
|---|---|---|---|---|---|
| embodiment | (° C.) | (° C.) | (° C.) | (J/g) | (J/g) |
| embodiment11 (PLA) | 54.86 | — | 154.97 | — | 37.11 |
| embodiment12 (PLA/PBS-20) | 57.7 | 95.08 | 150.20 | −23.65 | 21.39 |
| embodiment13 (PLA/PBS-40) | 59.9 | 98.79 | 144.13 | −22.01 | 19.28 |
| embodiment14 (PLA/PBS-60) | 55.5 | 102.37 | 142.95 | −20.95 | 18.74 |

Table 4 shows the relationship between the fiber tensile strength of PLA/PBS-sugar cane fiber composites

TABLE 4

| | Tensible | Tensile | Rupture | Break point |
|---|---|---|---|---|
| | strength | modulus | strain | Elongation |
| embodiment | (MPa) | (GPa) | (%) | (%) |
| embodiment15 | 39.27 ± 0.19 | 1.169 | 3.36 | 2.53 |
| (PLA) | | | | |
| embodiment16 | 43.35 ± 0.14 | 3.52 | 2.09 | 0.89 |
| (PLA/PBS-20) | | | | |
| embodiment17 | 57.62 ± 0.33 | 6.83 | 0.95 | 0.20 |
| (PLA/PBS-40) | | | | |
| embodiment18 | 33.05 ± 0.43 | 6.65 | 0.53 | 0.05 |
| (PLA/PBS-60) | | | | |

Table 5 shows the relationship between bending strength and impact resistance of PLA/PBS-sugar cane fiber composites.

TABLE 5

| | Impact resistance | Bending strength |
|---|---|---|
| | (J/m) | (MPa) |
| embodiment19 (PLA) | 22.19 | 39.38 |
| embodiment20 (PLA/PBS-20) | 16.87 | 42.45 |
| embodiment21 (PLA/PBS-40) | 13.13 | 55.81 |
| embodiment22 (PLA/PBS-60) | 11.68 | 32.31 |

The following table 6 shows the physical properties of biodegradable drinking straws with a ratio of 5 wt % plant fiber material (sugarcane fiber) and a total of 95 wt % biodegradable plastic (polylactic acid, polybutylene succinate).

TABLE 6

| | | | | Test | Reference |
|---|---|---|---|---|---|
| | item | unit | Test method | conditions | values |
| embodiment23 | Melt index | g/10 min | ASTM D-1238 | 230° C. × 2.16 kg | 5-7 |
| embodiment24 | Tensile strength | Kg/cm²(Mpa) | ASTM D-638 | 23° C. | 47-50 |
| embodiment25 | Break point Elongation | % | ASTM D-638 | 23° C. | 4-7 |
| embodiment26 | Bending modulus | Kg/cm²(Mpa) | ASTM D-790A | 23° C. | 70-75 |
| embodiment27 | Impacting strength | Kj/m² | ASTM D-256 | 23° C. | 3.5-4.5 |
| embodiment28 | proportion | | ASTM D-792 | 23° C./23° C. | 1.295 |

According to the composting plastic product verification plan jointly established by the International Biodegradable Products Institute (BPI) and the United States Composting Council (USCC), when the biodegradable drinking straw of the present invention meets the requirements of the American Society for Testing and Materials (ASTM) under the D6400 standard, that is, under the conditions of humidity of 50%, temperature of about 60° C., and sufficient oxygen, the biodegradable drinking straw of the present invention can decompose more than 90% within 180 days. In addition, when the biodegradable drinking straw of the present invention meets the EN13432 standard specified by ASTM, that is, under the conditions of humidity of 50%, temperature of about 60° C., and sufficient oxygen, the biodegradable drinking straw of the present invention can decompose more than 90% within 180 days; in addition, when the environmental protection straw of the present invention meets the EN13432 standard specified by ASTM, that is, under the conditions of humidity of 50%, temperature of 25±5° C., and sufficient oxygen, the biodegradable drinking straw of the present invention can be decomposed by more than 90% within 360 days; thus, it can truly reduce environmental pollution and provide a biodegradable drinking straw that meets the requirements of environmental protection.

In summary, the biodegradable drinking straw of the present invention is made of the plant fiber material and the biodegradable plastic selected from polylactic acid (PLA), polybutylene succinate (PBS) or a combination thereof, by use of the characteristics of plant fibers and biodegradable plastics, so that the straw can be quickly decomposed naturally in the environment after being buried, reducing environmental pollution, and meeting the environmental protection requirements. In addition, due to being made of the recyclable plant fibers such as sugarcane fibers, the biodegradable straw produced can reduce the manufacturing cost in addition to environmental protection requirements, and give the biodegradable straw good mechanical properties to achieve considerable durability to provide good use experience.

What is claimed is:

1. A biodegradable drinking straw, comprising:
a plant fiber material, which accounts for 5 wt % to 50 wt % of the total weight of the biodegradable drinking straw; and
a biodegradable plastic selected from polylactic acid (PLA), polybutylene succinate (PBS) or a combination thereof; the biodegradable plastic accounts for 50 wt % to 95 wt % of the total weight of the biodegradable drinking straw; the fiber material is mixed into the biodegradable plastic and mixed uniformly and then extruded to form a tube body of the biodegradable drinking straw by extrusion molding.

2. The biodegradable drinking straw as claimed in claim 1, wherein a thickness of the tube body is 80 to 800 μm.

3. The biodegradable drinking straw as claimed in claim 2, wherein the biodegradable plastic is selected from polylactic acid (PLA) or a combination of polylactic acid (PLA) and polybutylene succinate (PBS), the biodegradable drinking straw has a tensile strength of 30-60 MPa.

4. The biodegradable drinking straw as claimed in claim 2, wherein the biodegradable plastic is selected from polylactic acid (PLA) or a combination of polylactic acid (PLA) and polybutylene succinate (PBS), the biodegradable drinking straw has a tensile modulus of 1-7 GPa.

5. The biodegradable drinking straw as claimed in claim 2, wherein the biodegradable plastic is selected from polylactic acid (PLA) or a combination of polylactic acid (PLA) and polybutylene succinate (PBS), the biodegradable drinking straw has a rupture strain of 0.5-3.5%.

6. The biodegradable drinking straw as claimed in claim 2, wherein the biodegradable plastic is selected from polylactic acid (PLA) or a combination of polylactic acid (PLA) and polybutylene succinate (PBS), the biodegradable drinking straw has a break point elongation of 0.05-2.53%.

7. The biodegradable drinking straw as claimed in claim 1, wherein the plant fiber material is selected from sugarcane fiber, bamboo fiber, coconut fiber, palm husk fiber, coffee grounds, wine meal, wheat meal, cotton, hemp fiber, rice straw, rice husk, corn stalk, starch, wood flour or a combination thereof.

8. A method for manufacturing a biodegradable drinking straw comprising:
providing a plant fiber material, which accounts for 5 wt % to 50 wt % of the total weight of the biodegradable drinking straw;
providing a biodegradable plastic, which is selected from polylactic acid (PLA), polybutylene succinate (PBS), or a combination thereof; the biodegradable plastic accounts for 50 wt % to 95 wt % of the total weight of the biodegradable drinking straw;
mixing uniformly the plant fiber material and the biodegradable plastic at a temperature of 120 to 145° C., and then extrusion molding at 140 to 230° C. to form a tube body of the biodegradable drinking straw.

9. The method for manufacturing the biodegradable drinking straw as claimed in claim 8, wherein the biodegradable plastic is selected from polylactic acid (PLA) or a combination of polylactic acid (PLA) and polybutylene succinate (PBS), the biodegradable drinking straw has a tensile strength of 30-60 MPa.

10. The method for manufacturing the biodegradable drinking straw as claimed in claim 8, wherein the biodegradable plastic is selected from polylactic acid (PLA) or a combination of polylactic acid (PLA) and polybutylene succinate (PBS), the biodegradable drinking straw has a tensile modulus of 1-7 GPa.

11. The method for manufacturing the biodegradable drinking straw as claimed in claim 8, wherein the biodegradable plastic is selected from polylactic acid (PLA) or a combination of polylactic acid (PLA) and polybutylene succinate (PBS), the biodegradable drinking straw has a rupture strain of 0.5-3.5%.

12. The method for manufacturing the biodegradable drinking straw as claimed in claim 8, wherein the biodegradable plastic is selected from polylactic acid (PLA) or a combination of polylactic acid (PLA) and polybutylene succinate (PBS), the biodegradable drinking straw has a break point elongation of 0.05-2.53%.

13. The method for manufacturing the biodegradable drinking straw as claimed in claim 8, wherein the plant fiber material is selected from sugarcane fiber, bamboo fiber, coconut fiber, palm husk fiber, coffee grounds, wine meal, wheat meal, cotton, hemp fiber, rice straw, rice husk, corn stalk, starch, wood flour or a combination thereof.

14. The method for manufacturing the biodegradable drinking straw as claimed in claim 13, wherein the plant fiber material is sugarcane fiber.
